(19) United States
(12) Patent Application Publication
(10) Pub. No.: US 2002/0179643 A1
(43) Pub. Date: Dec. 5, 2002

(54) Fragrance emitting device

(75) Inventors: William Knight, London (GB); Kursty Groves, London (GB); Richard Paul Hayes-Pankhurst, London (GB)

Correspondence Address: LEYDIG VOIT & MAYER, LTD, 700 THIRTEENTH ST. NW, SUITE 300, WASHINGTON, DC, 20005-3960, US

(73) Assignee: Pankhurst Design and Developments Limited, London (GB)

(21) Appl. No.: 10/144,753

(22) Filed: May 15, 2002

(30) Foreign Application Priority Data
May 16, 2001 (GB) 0111984.1

(51) Int. Cl. B67D 5/62

(52) U.S. Cl. 222/146.2

(57) ABSTRACT

A fragrance emitting device comprising a container containing two differently colored, differently fragranced immiscible liquids, and a light source. The light source is located in the base of the device and shines through the container heating a first of said two immiscible liquids. Portions of said first immiscible liquid rise from a layer formed by said first immiscible liquid at the bottom of said container into a layer formed immediately above said first layer by said second immiscible liquid thereby heating said second immiscible liquid. Vapors are released from the device when portions of the first immiscible liquid reach the uppermost surface of the second immiscible liquid and also when the second immiscible liquid reaches a specified temperature. Preferably a replacement container and a cap are removable from the base for easy, inexpensive replacement of said immiscible liquids.

### BACKGROUND OF THE INVENTION

### FIELD OF THE INVENTION

The invention relates to a fragrance emitting device. In known fragrance emitting devices, a fragranced liquid held in a wick or pad is heated to cause partial evaporation of the liquid thereby causing a fragrance to be emitted from the device.

### SUMMARY OF THE INVENTION

According to a first aspect of the invention, there is provided a fragrance emitting device comprising a heal source and a container containing first and second immiscible liquids, the heat source heating the first immiscible liquid to cause the first liquid to rise from a position at the lower end of the container and pass through the second liquid towards a surface of the second liquid, one of said liquids including a fragrance released from said surface by said heated first liquid.

Preferably, the first liquid contains a fragrance, the first liquid rising to said surface to release the fragrance.

According to a preferred embodiment of the invention, the fragrance emitting device may further comprise a light source with the container comprising at least partially transparent walls so that light from the source passes through the walls.

### BRIEF DESCRIPTION OF THE DRAWINGS

FIG. 1 is a perspective view of a fragrance emitting device in operation;

FIG. 2 is an exploded view of the fragrance emitting device of FIG. 1;

FIG. 3 is a vertical cross-sectional view of the device of FIG. 2 in operation; and

FIG. 4 shows a replaceable cartridge of the device of FIGS. 1 to 3 being removed from a base section of the device of FIGS. 1 to 3.

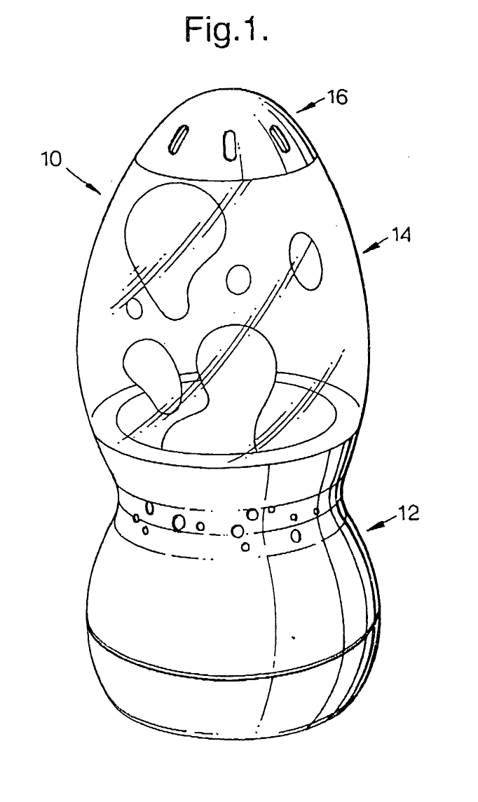

### DESCRIPTION OF THE PREFERRED EMBODIMENT

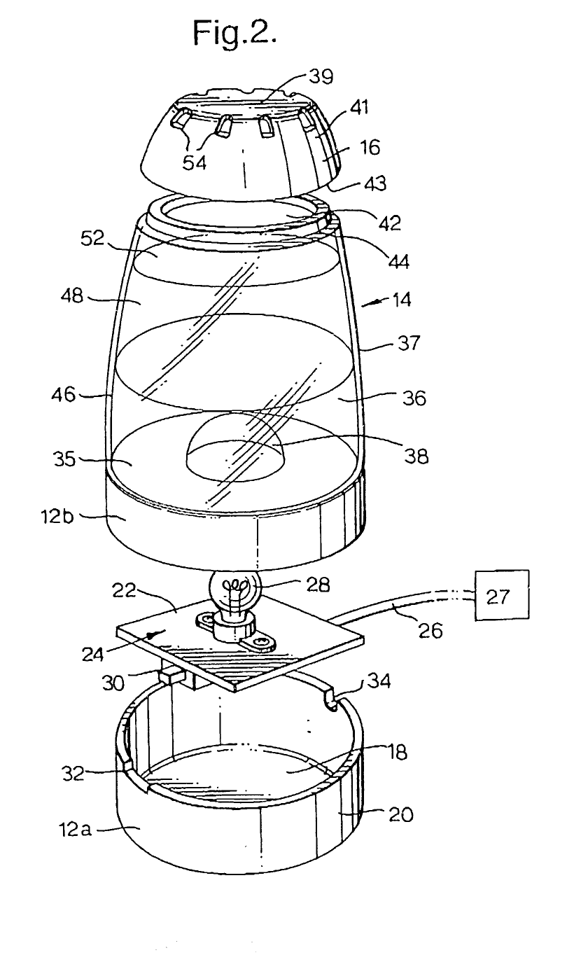

Referring to the Figures, the fragrance emitting device 10 comprises a base 12, a container 14 and a cap 16. FIG. 2 shows that base 12 comprises a cup shaped lower part 12a and a generally cylindrical upper part 12b. The lower part 12a has a base L8 and a vertically extending side wall 20. The upper edge of the vertically extending side wall 20 cooperates with and is connected to a corresponding lowermost edge of the upper part 12b. The upper edge of the side wall 20 includes a generally rectangular cut-out 32 and a diametrically opposite semi-circular cut-out 34, for purposes to be described below.

A rectangular platform 22 is located in the base 12 and carries electronic circuitry 24 which is connected by a lead 26 to a power source 27. The power source may be mains electricity, but it is to be understood that any suitable power source could be used. A lamp 28 is secured to the platform 22, and is controlled by the electronic circuitry 24 and a switch 30. the electronic circuitry 24 is of known type and will not be described in derail. The switch 30 protrudes through the cut-out 32 in the base side wall 20 for actuation by a user. The lead 26 leaves the base 12 through the semicircular cut-out 34.

The container 14 comprises a transparent hollow moulding 36 having a base 35 with a dome shaped inwardly extending protrusion 38 in the centre. The base 35 is surrounded by a wall 37 which curves inwardly to an opening 42 at its upper end. The opening 42 is surrounded by a stepped rim 44 for the location of the cap 16 (to be discussed below).

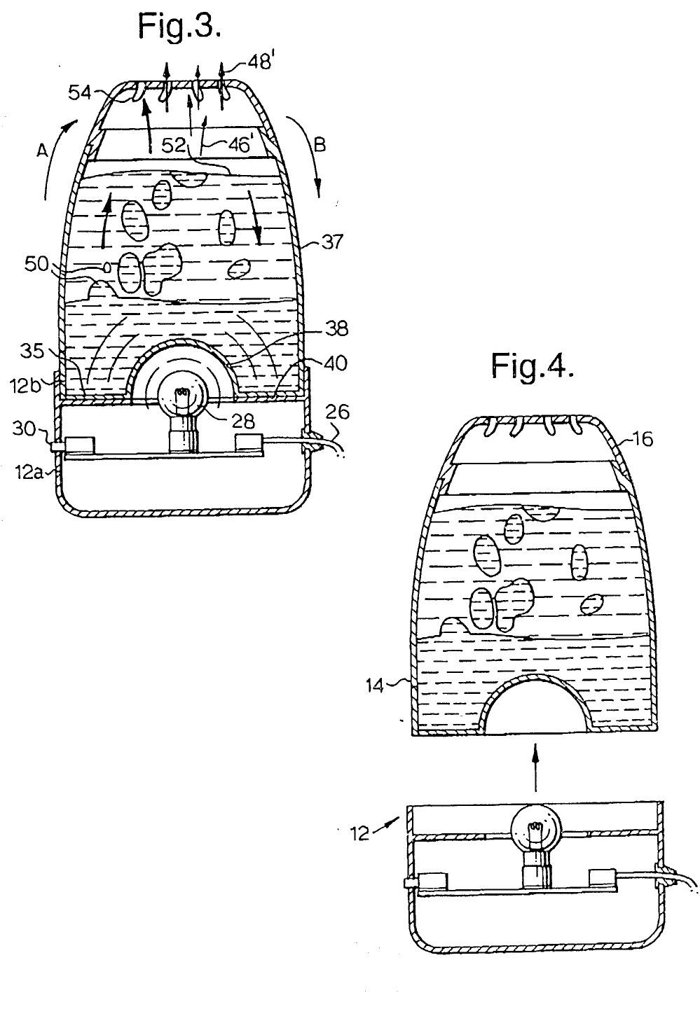

The base 35 of the container 14 sits on a radially inwardly directed annular flange 40 formed on the upper part 12b of the base 12. The lamp 28 protrudes through the open centre of annular flange 40 into the dome shaped protrusion 38 in the moulding 36. This is shown most clearly in FIG. 3.

The cap 16 is of inverted cup-shape with an end wall 39 and an outwardly curving surrounding side wall 41. A number of angularly spaced holes 54 extend through the cap 16 at the junction of the end wall 39 and the side wail 41 for a purpose to be described below. A lower edge 43 of the cap side wall 41 sits in the stepped rim 44 of the container 14 to locate the cap 16 on the container 14 with an outer surface of the cap side wall 41 contiguous with the outer surface of the container wall 37.

The container 14 contains a first liquid 46 and a second liquid 48. The liquids 46,48 are immiscible so that first liquid 46 forms a layer at the bottom of container 14 and second liquid 48, of lower density than the first liquid 46, forms a layer directly above the layer formed by the first liquid 46 and has a surface 52 adjacent but below the opening 42 at the upper end of the container 14. The first liquid 46 contains a fragrance.

Referring specifically to FIG. 3 which shows the device in operation, the device is operated by use of the switch 30 to connect the lamp 28 to the power source 27 via the electronic circuitry 24 and the lead 26. The lamp 2g radiates heat energy through the dome shaped protrusion 38 into the first liquid 46. The dome shape allows a maximum amount of light to pass into the container 14 and maximizes the surface area of the container 14, and thus of the first liquid 46 which is heated by the lamp 28.

When sufficient heat has been transmitted to the first liquid 46, portions 50 of first liquid 46 rise into the layer formed by second liquid 48 in the general direction indicated by arrow A. As the portions 50 rise through second liquid 48, heat is transferred from the portions 50 into the second liquid 48 thereby causing the portions 50 to cool and the second liquid 48 to heat up. This subsequent cooling of the portions 50 causes them to stop rising and eventually to reverse direction and fall back down in a general direction indicated by arrow B into the layer formed by first liquid 46 once more. The returning portions 50 thus recombine with the body of liquid 46 for reheating and a continuation of the process. The portions 50 may comprise discrete bubble-like portions which break away from the layer formed by first liquid 46 or they may comprise more vertically elongate portions which do nor break away from the layer formed by first liquid 46.

On first switching on the device 10, the liquids 46,48 will be relatively cool. The initial portions 50 will not reach the surface 52 of the second liquid 48 because the second liquid 48 will be significantly cooler than the first liquid 46, thus the portions 50 of relatively hot liquid 46 will initially be cooled relatively rapidly by second liquid 48. As the process continues, second liquid 48 will heat up due to the heat transfer from the portions 50 and also from the main body of the first liquid 46. As the second liquid 48 increases in temperature the portions 50 will rise increasingly close to the surface 52 until eventually some portions 50 will break the surface 52. This allows the release of fragrance vapours 46′ from first liquid 46.

The fragrant vapours 46′ rise from the surface 52 through the opening 42, into the space formed by the interior of the cap 16 and out into the atmosphere through the holes 54 in the cap 16. Thus the surrounding atmosphere will be filled with the fragrance. This will continue until the lamp 28 is switched-off using the switch 30. The first liquid 46 will then gradually cease rising through the second liquid 48 until the first liquid 46 reaches a rest position above the base 35 of the container 14. No fragrant vapours are then released.

It will be appreciated that the lamp 28 also transmits light through and out of the wall 37 so providing a light. Of course, both liquids 46,48 may be fragranced and the heating of the second liquid 48 by the first liquid 46 releases this fragrance from the second liquid 48 from the surface 52. Each liquid 46,48 may contain a different fragrance such that a combination of fragrances is emitted in varying rates; a first fragrance being emitted when the portions 50 of first liquid 46 break the evaporation surface and a second fragrance being emitted 48′ from more continuous evaporation of second liquid 48 at the surface 52. Equally it could be that only the second liquid 48 is fragranced.

Preferably the liquids 46,48 are differently coloured such that the combination of moving portions 50 of a first colour within a, liquid of a second colour and light produces a pleasant visual effect.

It will be understood that it is equally possible to have more than two immiscible liquids in a container 14, one or each of which may be differently coloured and differently fragranced to produce more complex visual and olfactory stimulation.

The device 10 allows easy replacement of a container 14 when all the fragrance or fragrances have been emitted or when it is desired to change the fragrance. FIG. 4 shows the container 14 and cap 16 of the device 10 being separated from the base 12. A replacement container 14 and cap 16 are then located on the base 12. This arrangement enables a prolonged life of the device at a minimum cost because there is no need to replace the relatively expensive base 12 containing all of the electronics 24,26,28,30 when the fragrance of the liquids is exhausted. Likewise container 14 could be separated from both the base 12 and the cap 16 to be replaced by another container 14 thus avoiding the unnecessary replacement of cap 16. It would, of course, be just as simple to replace one container 14 and cap 16 with another containing liquids of a different colour and/or fragrance combination if it were desired, even if the previous container 14 and cap 16 had not yet been exhausted.

Another method of replacing the liquids 46,48 would be to remove cap 16 from container 14 in order to pear away the old liquids 46,48 through opening 42 and to refill the container 14 with new liquids 46,48.

It will be appreciated that the fragrance emitting device 10 would work equally effectively as a fragrance emitter if the lamp 28 were replaced by a non-light emitting heat source. In this case there would be no need for the immiscible liquids to be differently coloured, nor would it be necessary for container 12 to comprise a transparent moulding 36.

The opening 42 at the upper end of the container 14 may be covered with a cover such as a membrane that allows vapour to pass through but prevents the liquids spilling.

The cap 16 may contain a fan to dispense the vapours through the holes 54. This may be powered via the electronic circuitry 24.

We claim:

1. A fragrance emitting device comprising a heat source and a container containing first and second immiscible liquids, said heat source hearing said first immiscible liquid to cause said first liquid to rise from a position at the lower end of said container and pass through said second liquid towards a surface of said second liquid, one of said liquids including a fragrance released from said surface by said heated first liquid.

2. A device according to claim 1, wherein the first liquid contains a fragrance, said first liquid rising to said surface to release said fragrance.

3. A device according to claim 1, wherein the second liquid contains a fragrance, said heated first liquid causing release of said fragrance from said surface.

4. A device according to claim 1, wherein each of said first and second liquids contains a fragrance, and the fragrance in said first liquid is different from the fragrance in said second liquid.

5. A fragrance emitting device according to claim 1 wherein the container comprises at least partially translucent walls and said device includes a light source so that light from said source passes through said translucent walls.

6. A fragrance emitting device according to claim 5, wherein said light source is also the heat source.

7. A fragrance emitting device according to claim 1, wherein each of said immiscible liquids is differently coloured.

8. A fragrance emitting device according to claim 1, wherein the device comprises a base containing the heat source and supporting the container, said container being removable from said base.

9. A device according to claim 8, wherein said base is formed in two separable parts providing a housing for said heat source, one of said parts containing a supporting surface and the other part engaging said container.

10. A device according to claim 8, wherein said heat source projects from said base, said container including a floor having an inwardly directed cavity for receiving said heat source and for providing a heat transfer surface between said heat source and said first liquid.

11. A device according to claim 1, wherein the container includes an open upper end covered by a perforate cap for allowing the passage therethrough of released fragrance.

12. A fragrance emitting device comprising:
a container;
a first liquid within said container;
a fragrance within said first liquid;
a second liquid within said container, said second liquid being immiscible with said first liquid and less dense than said first liquid;
a surface formed on said second liquid;
an upper end to said container;
a lower end to said container;
at least partially translucent walls of said container between said upper end and said lower end; and
a lamp providing a source of light emitted through said translucent walls and providing a source of heat to heat said first liquid which rises through the second liquid to release the fragrance at the surface.
